(19) United States
(12) Patent Application Publication
(10) Pub. No.: US 2001/0033329 A1
(43) Pub. Date: Oct. 25, 2001

(54) Remote video surveillance server

(76) Inventors: Jian Zhang, Hangzhou (CN); Huiming Tang, Hangzhou (CN); Caoming Han, Hangzhou (CN); Hongtao Wang, Hangzhou (CN); Yaqun Yao, Hangzhou (CN)

Correspondence Address: Joe Zheng, Silicon Valley Patent Agency, 7394 Wildflower Way, Cupertino, CA, 95014, US

(21) Appl. No.: 09/729,072

(22) Filed: Dec. 4, 2000

(30) Foreign Application Priority Data
Apr. 22, 2000 (CN) CN00208580.1

(51) Int. Cl. H04N 7/18

(52) U.S. Cl. 348/143

(57) ABSTRACT

The remote video surveillance server comprises a certain number of channel interface units directed to field terminals for receiving the video, audio and alarm signals in the surveillance site from said field terminals in the remote end and transmitting the audio and control information from the view stations to said field terminals respectively, an information process kernel composed of a computer and a software and connected to said channel interface unit directed to field terminal by a computer bus, and a certain number of view station interface units connected to said information process kernel by said computer bus. As well as the signal transmission between different type channels, the point-to-multipoint or multipoint-to-point video surveillance can be realized.

### BACKGROUND OF THE INVENTION

1. Field of the Invention

The invention relates to a remote video surveillance server and in particular to a remote video surveillance system implementing its surveillance function by E1 channel and Local Area Network (LAN).

2. Background of the Related Art

In recent years, by the impetus from application needs and the drive of communication and video compression technologies, the video surveillance technology, particularly the remote video surveillance technology, is developing rapidly, and the video surveillance systems based on different transmission means such as telephone line, Ethernet, and E1 channel are developed as a response naturally.

Today, however, these video surveillance systems are hard to meet the application requirements in many fields, and particularly demonstrate a number of shortcomings when there are requirements such as simultaneous video surveillance of multiple field terminals by a single view station. Furthermore, the current video surveillance systems are lack of channel adaptability, and especially lower in their interconnection capability with the internal LANs for enterprise, which is very popular today.

### SUMMARY OF THE INVENTION

One of the objects of the invention is to provide a video surveillance system in which the point-to-multipoint or multipoint-to-point video surveillance can be realized readily, and the signal transmission between communication channels can be performed well.

A remote video surveillance server according to the invention comprises: a certain number of channel interface units to communicate with a field terminal at substation for receiving video, audio and alarm signals in a surveillance site from the field terminal and transmitting the audio and control information from a view station to the field terminal respectively; a certain number of channel interface units to communicate with the view stations for receiving the audio and control signals from view stations and transmitting the video, audio and alarm information from the field terminal to the view stations respectively; an information process kernel for collecting and sorting the data received by the channel interface units to communicate with the field terminal from each field terminal, and organizing them into the data frames to be transmitted on the Ethernet connecting the server with the view station, meanwhile, collecting and sorting the audio and control signals received by the channel interface units to communicate with view stations from the view stations, and organizing them into the data frames to be transmitted on the Ethernet connecting the server with the field terminal.

Objects and features of the present invention, together with the foregoing, are attained in the exercise of the invention in the following description and resulting in the embodiment illustrated in the accompanying drawings.

### BRIEF DESCRIPTION OF THE DRAWINGS

These and other features, aspects, and advantages of the present invention will become better understood with regard to the following description, appended claims, and accompanying drawings where:

FIG. 1 is a block diagram showing an embodiment of the remote surveillance server according to the invention;

FIG. 2 is a block diagram showing a remote video surveillance system using the embodiment of remote surveillance server according to the invention shown in FIG. 1;

FIG. 3 illustrates a system configuration of an embodiment of the surveillance server;

FIG. 4 illustrates a configuration of a channel interface unit for a field terminal;

FIG. 5 illustrates a flowchart for transmitting control data from a server to a remote end;

FIG. 6 illustrates a flowchart for receiving data from a remote end by a server; and

FIGS. 7a to 9 illustrate respectively an exemplary circuit implementation and structure according to one embodiment of the invention.

### DETAILED DESCRIPTION OF THE PREFERRED EMBODIMENT

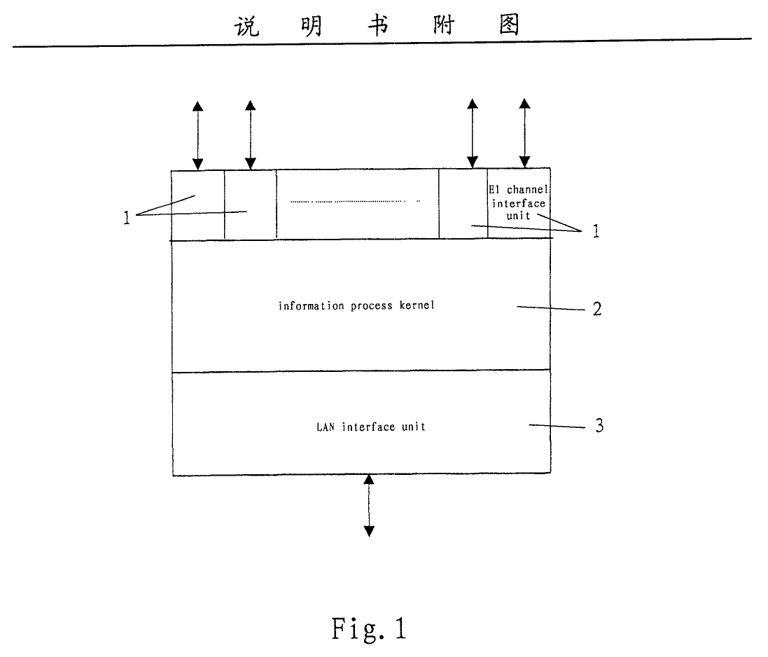

Referring to FIG. 1, it is a configuration block diagram showing an embodiment of a remote surveillance server according to the invention. The surveillance server shown in FIG. 1 comprises several E1 channel interface units 1, an information process kernel 2 and a LAN interface unit 3. As a hub of an overall video surveillance system, the main function of a surveillance server is to realize the interconnection between E1 channel and LAN (mainly packet/depacket and transmit the data frames on the channel); moreover, the server performs the multiple points switching in a multipoint control unit (MCU). The server through the E1 interface unit receives the audio, video and alarm data from a field terminal. The information process kernel to form an alarm signal correspondingly sorts the alarm data from each field terminal. For the audio and video streams, the IP multicast protocol is used by the information process kernel 2, in which the video and audio streams from each substation are formed a transmission source of a monitor group, and transmitted to the LAN through the LAN interface. The view station as necessary may include one monitor group or a plurality of monitor groups such that the video and audio data from one transformation substation or a plurality of such substations can be received individually or simultaneously and a true multipoint system can be realized. Thus, the data transmission between E1 channel and LAN is realized readily, and the data transmission between other type channels also can be realized simply by a change of the channel interface unit in practical applications.

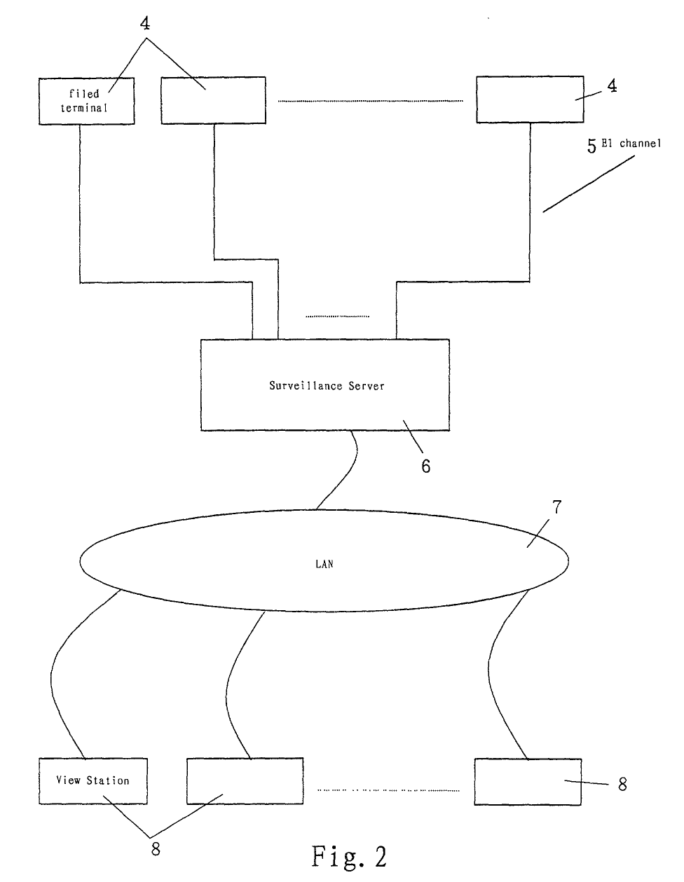

Referring to FIG. 2, there is a block diagram showing a remote video surveillance system based on the embodiment of a remote surveillance server according to the invention as shown in FIG. 1. In the system shown in FIG. 2, the E1 channel 5 is employed to realize the interconnection between the field terminal and the surveillance server, and the interconnection between the surveillance server and the view station is achieved by a LAN (Local Area Network) 7. As shown in FIG. 2, the system comprises a field terminal 4 for collecting the video and sound in a surveillance scene and the alarm signal of a surveillance site to form E1 frames in a determined format and transmitting it to the surveillance server through the E1 channel 5, and for receiving the control and audio data sent by the surveillance server along the E1 channel and transferring the control information and audio data to the corresponding surveillance device respectively. In FIG. 2, the surveillance server 6 acts as a channel interconnection means and a multipoint control unit in the overall system. As described in the exemplification shown in FIG. 1, the server 6 comprises several E1 channel interfaces and a LAN interface for receiving the surveillance information from some field terminals simultaneously through the E1 interface and transmitting all of them to view stations through the LAN interface after the process taken by the information process kernel for them, and for receiving the control information from the view stations through the LAN interface and transmitting to the field terminal through the corresponding E1 interfaces. In the system, the view station 8 is further comprised. The view station is an interface between the surveillance system and the surveillant. Through the view station, the surveillant obtains all information about the surveillance site, and issues the operating commands required also through such terminal. Furthermore, the view station performs decompression and replaying for the video data sent from the server, as well as replaying the audio data. Thus, it performs real-time decompression for the videos from a plurality of remote substations simultaneously, and carries out multi-windows display to realize a true multipoint monitor.

The essential characteristics of the invention will be described through the following particular embodiment.

In an exemplary embodiment, an industrial computer is used as the remote video surveillance server, wherein the channel interface unit to communicate with the field terminal is realized by using an E1 transceiver card inserted to the PCI slot in the computer; the channel interface unit to communicate with the view stations is realized by using the normal Ethernet card; and the information process kernel is realized by the software programming mainly.

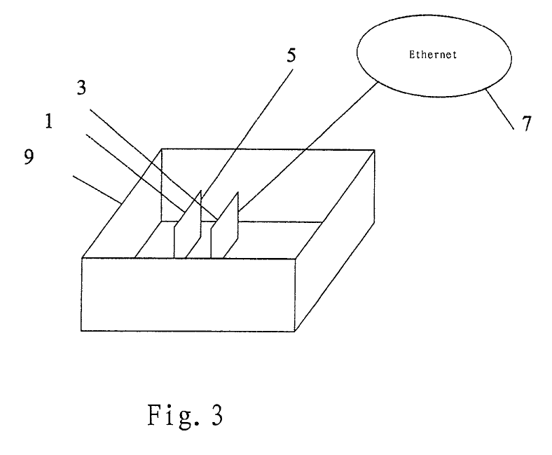

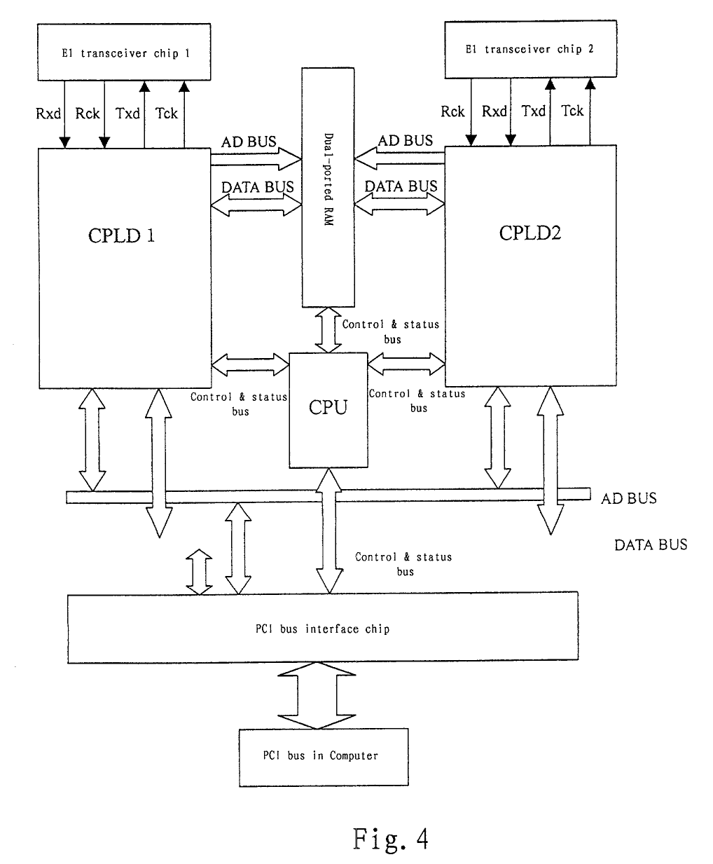

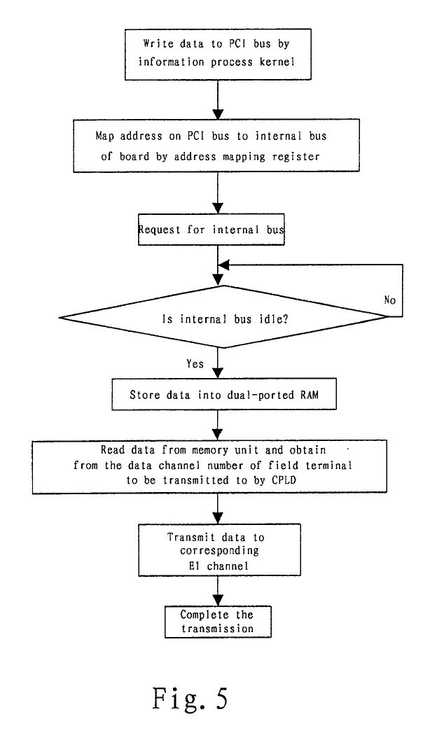

In FIG. 3, 9 is an industrial computer; 1 is a channel interface unit for field terminal; 3 is a channel interface unit for view station (i.e. an Ethernet card); 5 is an E1 channel; and 7 is the Ethernet. The connections among them are as follows: 9 is connected to 1 through the PCI bus; 1 is connected to E1 channel 5; 9 is connected to 3 through the PCI bus; and 3 is connected to the Ethernet.

The industrial computer is used to implement the information process kernel in software manner. The information process kernel will be described later. The Ethernet card, being a channel interface unit for terminal, is not described herein. In the following, the details of a channel interface for field terminal will be given at first. In the embodiment, surveillance information from two field terminals can be received simultaneously through the E1 channel, and interfaced to the industrial computer via a PCI bus. The industrial computer comprises: a single chip processor for initializing each chip on the board and making the related logical decisions and arbitration; two E1 transceiver chips for transmitting/receiving two signals on E1 channel; two CPLD (programmable logic device) chips to process the transmitting/receiving data in two E1 transceiver chips respectively; a dual-ported RAM chip for buffering two audio, video and alarm data from the field terminal and two control and audio data sent from terminal surveillant to the field terminal; and a PCI interface chip to perform the information exchange between channel interface unit for field terminal and industrial computer.

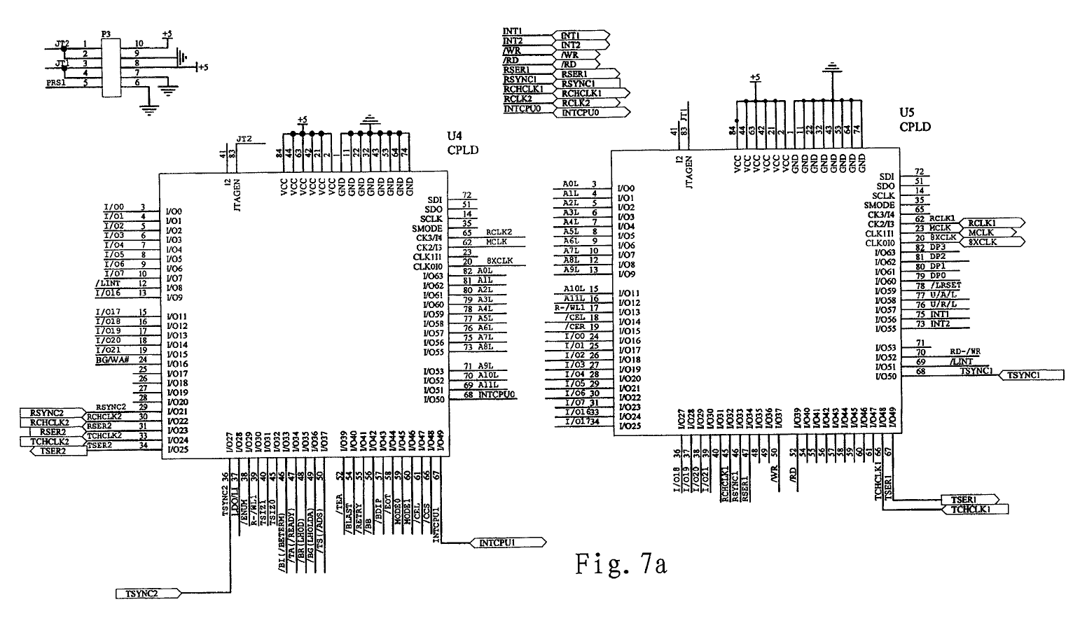

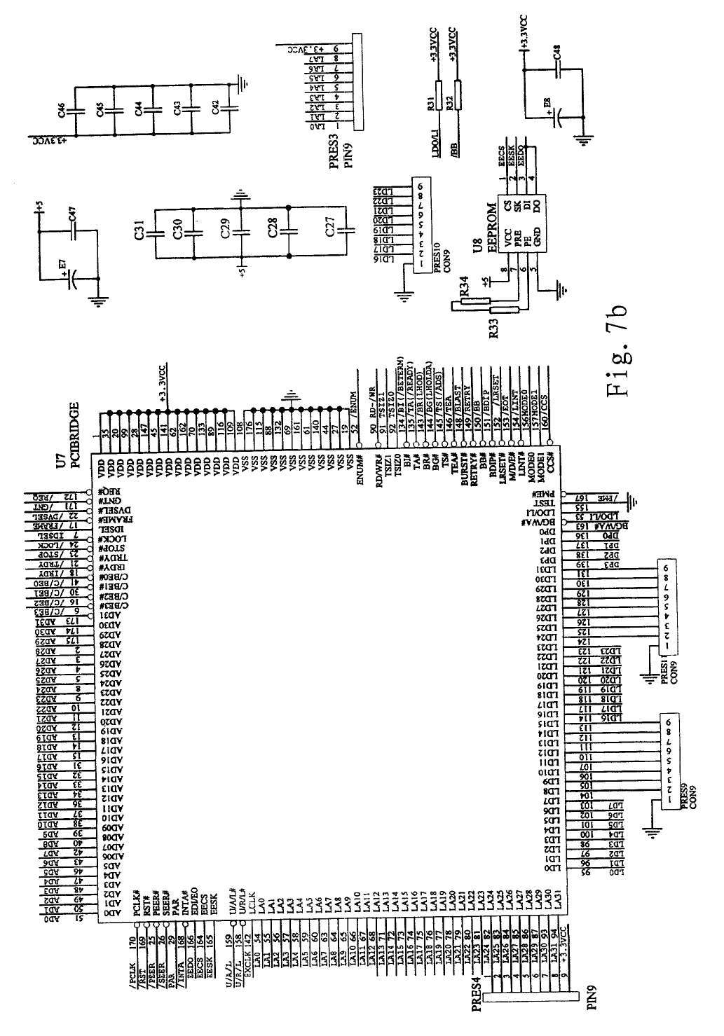

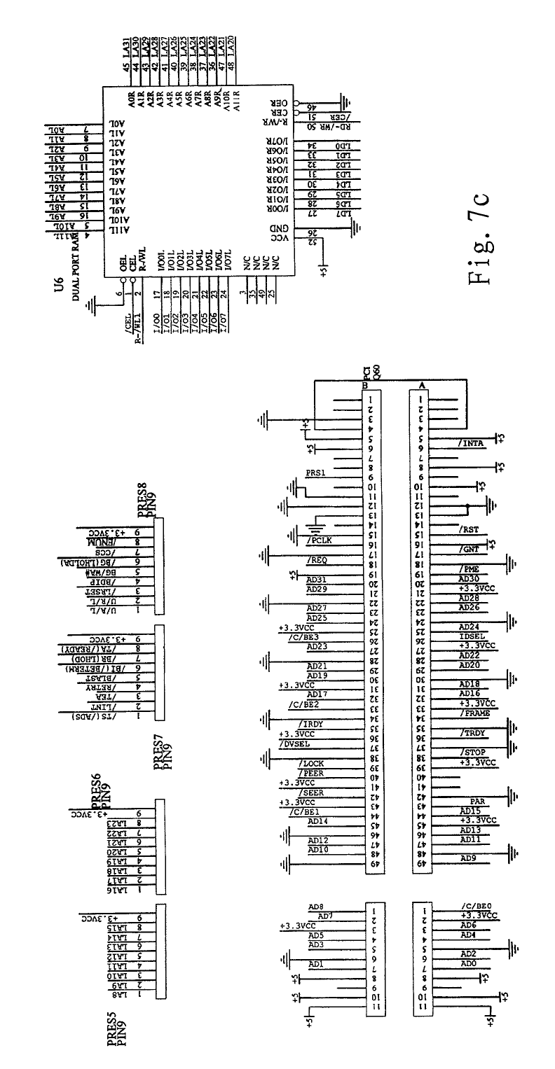

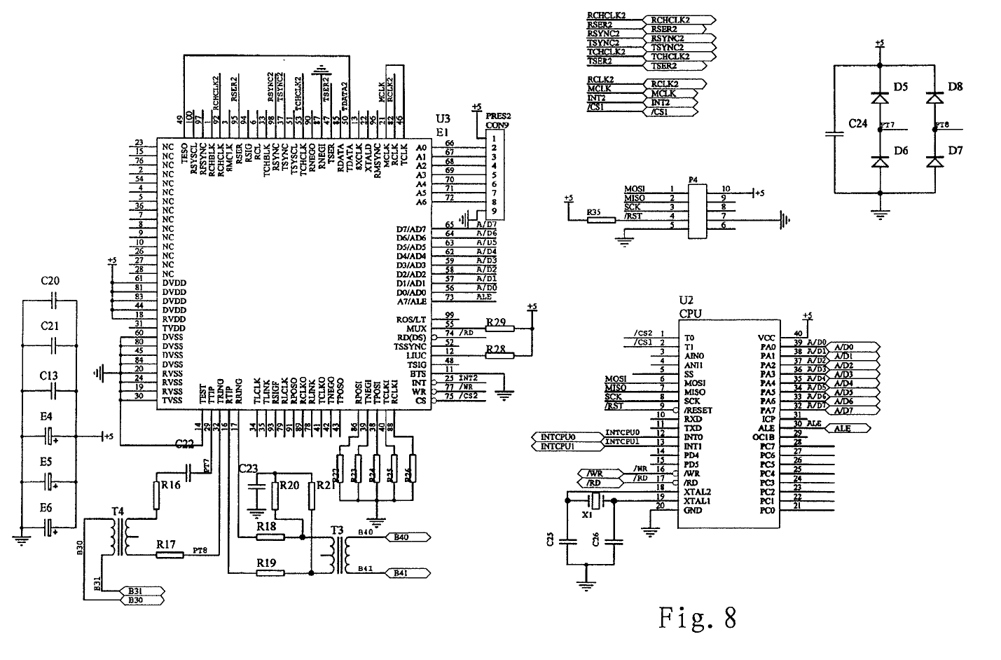

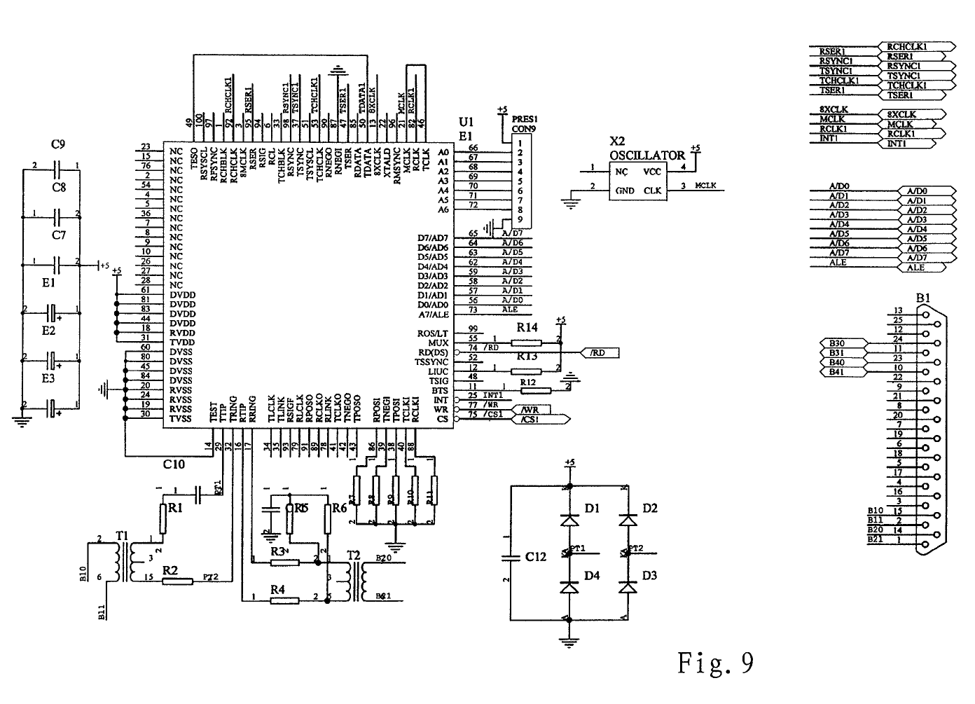

Referring to the configuration block diagram and the circuit principle diagram as shown in FIGS. 7a-9, U1 represents the E1 transceiver chip 1; U3 represents the E1 transceiver chip 2; U2 is a single chip processor; U4 represents the CPLD 1; U5 represents the CPLD 2; U6 is a dual-ported RAM; and U7 is a PCI interface chip.

The embodiment shown in the diagrams comprises a two channels transmitting/receiving configuration. In the diagrams, through the transmitting clock line Tck, transmitting data line TxD and receiving clock line Rck, receiving data line RxD, the channel transceiver chips are connected respectively to CPLD1 and 2 which are connected to the dual-ported RAM respectively by the DATA BUS and the AD BUS; the dual-ported RAM is connected to the I/O bus in CPU; the CPLD 1 and 2 are connected to the I/O bus in CPU, and also connected to the DATA BUS and AD BUS in the PCI bus control chip; and the CPU is connected to the control bus and status bus in the PCI bus control chip through its I/O bus, and the PCI bus control chip is connected to the computer bus.

In the embodiment, the operating flow is as follows. For the direction that data runs from the field terminal to the view station, the E1 transceiver chip 1 and 2 receives data stream from the channel communicating with view station, and sends it to the CPLD 1 and 2 in which the data stream is converted to a format required in the process, and the bit synchronization and word synchronization are realized in this format conversion process, then the converted data are stored into the dual-ported RAM. Moreover, the CPLD 1 and 2 read the data from the dual-ported RAM, and make a request to CPU for reading and writing. According to the result arbitrated by CPU, the process determines whether the data are written into the PCI bus control chip, and further the data are written into the computer by the PCI bus control chip through the computer bus. That the PCI bus control chip reads from and writes into the computer bus is controlled by CPU. For the direction that data runs from the view station to the field terminal, CPU controls the PCI bus control chip to read data from the computer through the computer bus, and a request for reading the data is sent to the CPU by the CPLD 1 and 2. According to the result arbitrated by CPU, the process determines whether the data are read from the PCI bus control chip, and the read data are written into the dual-ported RAM. Moreover, CPLD 1 and 2 read the data from the dual-ported RAM, and send them to the E1 transceiver chip 1 and 2 to transmit to the channel after they are converted to a serial data stream.

As described above, the transmitting refers to a control data sending from the server to the remote end, and its flowchart is given in brief (as shown in FIG. 5).

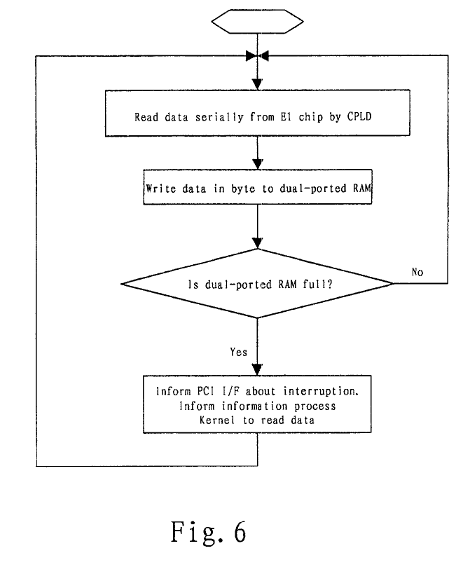

For the receiving process, the data from remote end are sent into the PCI bus, so they can be read from the PCI bus by the information process kernel, and formed into a determined format. Its flowchart is shown in FIG. 6.

The information process kernel is implemented in software manner. The kernel comprises: an interface module directed to the field terminal channel interface unit card for driving the card and performing the data exchange between information process kernel and field terminal channel interface unit; an interface module directed to the view station interface network for framing and deframing the data and performing the data exchange between information process kernel and terminal channel interface unit (i.e. the Ethernet). In the exemplary embodiment, the RTP (Real-time Transport Protocol) and RTCP (Real-time Transport Control Protocol) are used for the view station interface network to obtain a real-time reliable video and audio data transmission in the present multipoint system. The RTP is responsible for a real-time transmission of the media data stream, and the RTCP ensures the service quality of media transmission by checking the feedback information from receiving end, for example, by taking an adjustment of code rate and a change of coding method at the coding end, the degradation of receiving video and audio signals due to network blocking can be prevented. The RTP and RTCP are based on the multicast technology, namely the surveillance data in each channel are grouped, and sent to the Ethernet in-group. Each view station can add on one or more data group(s) as its own requirement so that point-to-multipoint or multipoint-to-point surveillance can be obtained.

In summary, according to the invention, the design of a remote video surveillance server results in a great improvement of the channel adaptability in the overall video surveillance system, and the signal transmission between different type networks can be realized by changing the channel interface unit; moreover, the requirement of point-to-multipoint or multipoint-to-point surveillance can be met with the manner described above.

What is claimed is:

1. A remote video surveillance server comprising:
A number of channel interface units [1] directed to field terminals for receiving video, audio and alarm signals in a surveillance site from said field terminals and transmitting the video, the audio and control information from view stations to said field terminals respectively, wherein one of said channel interface units comprises:
a) a number of channel transceiver chips to communicate with said field terminals, connected to a logic control module through a data line and a clock line, for transmitting/receiving signals from a channel;
b) a logic control module including a number of programmable devices, a single chip processor and a memory for receiving data from said channel transceiver chips through the data line and the clock line and transmitting the data to said channel transceiver chips, moreover, for receiving the data from the bus control module through the data line and the address line and transmitting the data to the bus control module, wherein said memory is connected to said programmable devices for buffering the data received from said channel transceiver and the data received from said bus control module; and
c) a bus control module with one end connected to said logic control module and another end connected to a computer bus;
an information process kernel [2] including a computer and a software module and connected to said channel interface unit directed to said field terminal [1] by said computer bus; and
a number of view station interface units [3] connected to said information process kernel by said computer bus.

2. The remote video surveillance server in accordance with claim 1, wherein one of said channel interface units comprises:
two channel transceiver chips [a] and [b],
programmable devices [a], [b], [c] and [d],
the memory devices [a] and [b], and
a single chip processor, wherein said channel transceiver chips [a] and [b] are connected to said programmable devices [a] and [d] respectively through the transmitting clock line Tck, transmitting data line TxD and receiving clock line Rck, receiving data line RxD, said programmable devices [a] and [b] are connected to said memory devices [a] and [b] respectively through the DATA BUS and the AD BUS, said memory devices [a] and [b] are connected to said programmable devices [b] and [c] respectively through the DATA BUS and the AD BUS, said programmable devices [b] and [c] are connected to the I/O bus in said single chip processor (CPU), and also connected to the DATA BUS and the AD BUS in a computer bus control chip, said single chip processor (CPU) is connected to the control bus and the status bus in said computer bus control chip through its I/O bus, and said computer bus control chip is connected to said computer bus.

3. The remote video surveillance server in accordance with claim 1 or 2, wherein said channel transceiver chip is an E1 or a DDN or an ISDN transceiver chip, said programmable device is a CPLD or a FPGA or a DSP, said memory is a single chip dual-ported RAM or a two chips RAM, said computer bus is an ISA bus or a PCI bus.
